(19) United States
(12) Patent Application Publication
(10) Pub. No.: US 2013/0329292 A1
(43) Pub. Date: Dec. 12, 2013

(54) LENS MECHANISM AND DEVICE USING THE SAME

(71) Applicant: ABILITY ENTERPRISE CO., LTD., Taipei (TW)

(72) Inventor: Chih-Jung WU, Taipei (TW)

(21) Appl. No.: 13/897,142

(22) Filed: May 17, 2013

(30) Foreign Application Priority Data
Jun. 7, 2012 (TW) 101120555

(51) Int. Cl. G02B 7/02; G02B 13/00; G02B 27/64

(52) U.S. Cl. CPC G02B 7/021; G02B 27/646; G02B 13/009
USPC 359/557; 359/817; 359/694

(57) ABSTRACT

A lens mechanism and a device using the same are provided. The lens mechanism has an optical axis and comprises a zoom module, a focus module and a focusing lens group. The zoom module performs an optical compensation. The focus module comprises a rotatable arm. The focusing lens group is disposed on the rotatable arm, wherein when the lens mechanism is in a stand-by state, the focusing lens group is located at the optical axis; when the lens mechanism is in a close-end, the focusing lens group is away from the optical axis.

This application claims the benefit of Taiwan application Serial No. 101120555, filed Jun. 7, 2012, the subject matter of which is incorporated herein by reference.

### BACKGROUND OF THE INVENTION

1. Field of the Invention

The invention relates in general to a lens mechanism and device using the same, and more particularly to a lens mechanism applied in an image device and device using the same.

2. Description of the Related Art

Current electronic product stress multi-function and slim, thin and compact size. In addition, to comply with requirement for user, the electronic product in market mounts lens mechanism having capability of image capturing.

However, conventional lens mechanism is not able to comply with thin type and quality of image simultaneously. In contrary, to comply with thin type, quality of image is usually sacrificed. Or, to comply with better quality of image, thickness of the lens mechanism is usually disregarded.

### SUMMARY OF THE INVENTION

The invention is directed to a lens mechanism and a device using the same. In an embodiment, the focusing of the lens mechanism is impervious to the motion of the lens mechanism focus.

According to an embodiment of the present invention, a lens mechanism is provided. The lens mechanism comprises a zoom module, a focus module and a focusing lens group. The focus module comprises a rotatable arm. The focusing lens group is disposed on the rotatable arm. When the lens mechanism is in a stand-by state, the focusing lens group is located at an optical axis. When the lens mechanism is in a collapse state, the focusing lens group is away from the optical axis by the rotatable arm.

According to another embodiment of the present invention, a focus module is provided. The focus module is disposed on a lens mechanism and comprises a rotatable arm which is connected to a focusing lens group. When the lens mechanism is in a stand-by state, the rotatable arm let the focusing lens group is located at the optical axis. When the lens mechanism is in a collapse state, the rotatable arm let the focusing lens group away from the optical axis.

According to another embodiment of the present invention, a lens mechanism is provided. The lens mechanism has an optical axis and comprises an optical system. The optical system comprises at least one zooming lens group and a focusing lens group. The lens mechanism comprises a focus module. The focus module comprises a rotatable arm. The focusing lens group is disposed on the rotatable arm. When the lens mechanism is in a stand-by state, the rotatable arm let the focusing lens group to be located at the optical axis.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a cross-sectional view of a device according to an embodiment of the invention;

FIG. 2 shows a cross-sectional view of the lens mechanism of FIG. 1 being in a collapse state;

FIG. 3 shows a local three-dimensional view of the focus module of FIG. 1; and

FIG. 4 shows a local three-dimensional view of the focus module of FIG. 2;

### DETAILED DESCRIPTION OF THE INVENTION

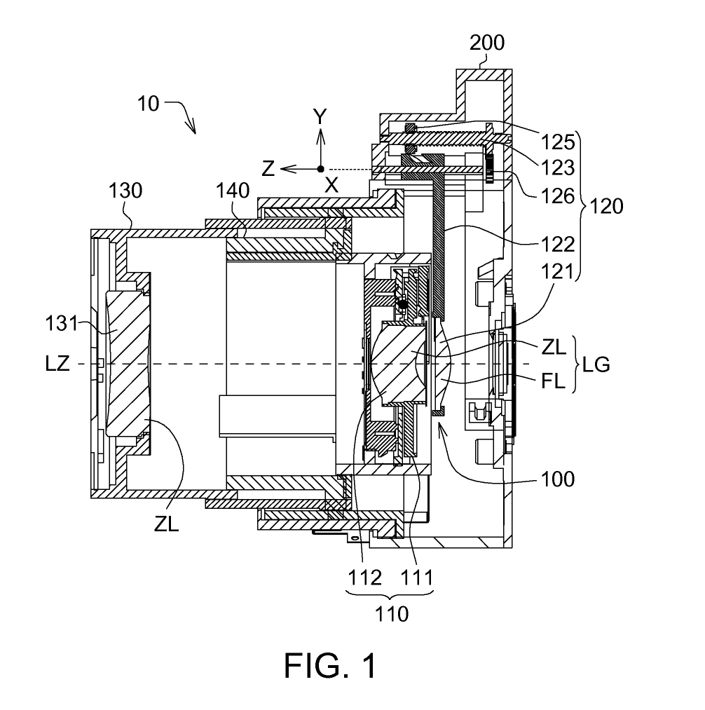

FIG. 1 shows a cross-sectional view of a device according to an embodiment of the invention. The device, such as an electronic device 10, comprises a lens mechanism 100, a casing 200 and an image capturing unit (not illustrated), wherein the lens mechanism 100 is disposed on the casing 200.

The lens mechanism 100 has an optical axis LZ and comprises an optical system LG, a zoom module 110 and a focus module 120. In the present embodiment, the electronic device 100 is a digital camera, for example. In other embodiment, the lens mechanism 100 may be used in various electronic devices with image capturing function, and may be realized by such as digital camera, digital video recorder, mobile phone or personal digital assistant (PDA).

The optical system LG comprises a zooming lens group ZL and a focusing lens group FL. The zooming lens group ZL at least comprises one lens 112 and 131 for zooming between a telephoto-end and a wide-angle end. The focusing lens group FL comprises at least a focus lens 121 for adjusting an image-formed focus during focusing.

The zoom module 110 is used for optically compensating and comprises an optical image stabilizer (OIS) 111, wherein at least one lens 112 of the zooming lens group ZL is disposed on the optical image stabilizer 111. The lens 112 executes an optical compensation in two dimensions or circumference perpendicular to the optical axis LZ through the optical image stabilizer 111. The lens 112 made from a glass and a plastic may be a convex lens, a concave lens, an aspheric surface lens, a free-form curved surface lens and/or combination thereof. The optical image stabilizer 111 drives the lens 112 to compensate an image deviation caused the amount of tremor by hand according to a relative displacement between the optical system LG and the image capturing unit.

The focus module 120 comprises a rotatable arm 122, wherein the focus lens 121 is disposed on the rotatable arm 122. When the lens mechanism 100 is in a stand-by state (as illustrated in FIG. 1), the focus lens 121 is located at the optical axis LZ for precisely focusing. In addition, the stand-by state is referred to a state, such as the wide-angle end, the telephoto-end or a preparative state between the wide-angle end and the telephoto-end, which is ready for taking a picture

In addition, the lens mechanism 100 further comprises a first barrel 130 and a second barrel 140, wherein the lens 131 is disposed on at least one of the first barrel 130 and the second barrel 140. In another embodiment, the lens mechanism 100 further comprises other barrel on which the lens of the zooming lens group ZL can be selectively disposed.

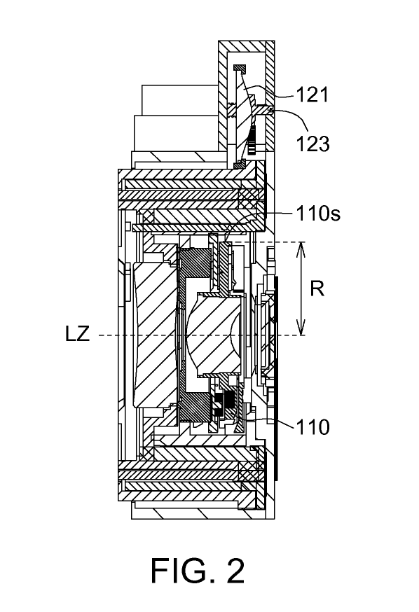

FIG. 2 shows a cross-sectional view of the lens mechanism of FIG. 1 being in a collapse state. During the lens mechanism 100 being changing to the collapse state (as illustrated in FIG. 2) from the stand-by state (as illustrated in FIG. 1), the rotatable arm 122 (the rotatable arm 122 can't be viewed in FIG. 2 due to an angle of view) brings the focus lens 121 to be away from the optical axis LZ. For example, the rotatable arm 122 brings the focus lens 121 outside a periphery 110s of the zoom module 110. In the present embodiment, a length of the rotatable arm 122 is larger than a radial size R of the focus module 120, and thus the rotatable arm 122 can bring the focus lens 121 outside a periphery 110s of the zoom module 110. In contrary, during the lens mechanism 100 being changing to the stand-by state (as illustrated in FIG. 1) from the collapse state (as illustrated in FIG. 2), the rotatable arm 122 leads the focus lens 121 to be located at the optical axis LZ.

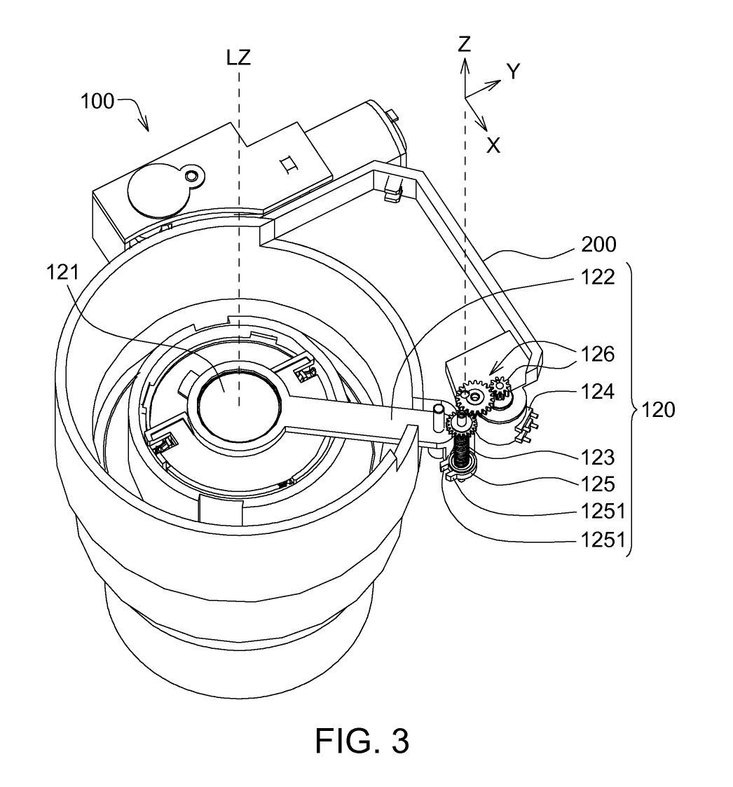

FIG. 3 shows a local three-dimensional view of the focus module of FIG. 1. The focus module 120 further comprises a leading screw 123, a driver 124, a guider 125 and a transmission mechanism 126.

The motion of the leading screw 123 is restricted in the Z-axis to avoid moving in the Z-axis. The Z-axis is substantially parallel to the optical axis LZ; however, in another embodiment, an angle, such as acute angle, can be included between the Z-axis and the optical axis LZ.

The driver 124, such as a motor, can drive the leading screw 123 to revolve on its own axis around the Z axis.

The guider 125 is screwed to the leading screw 123. When the leading screw 123 revolves on its own axis, the guider 125 revolves on its own axis around the Z-axis and moves in a straight line along the Z-axis because the leading screw 123 is not able to move in a straight line along the Z-axis.

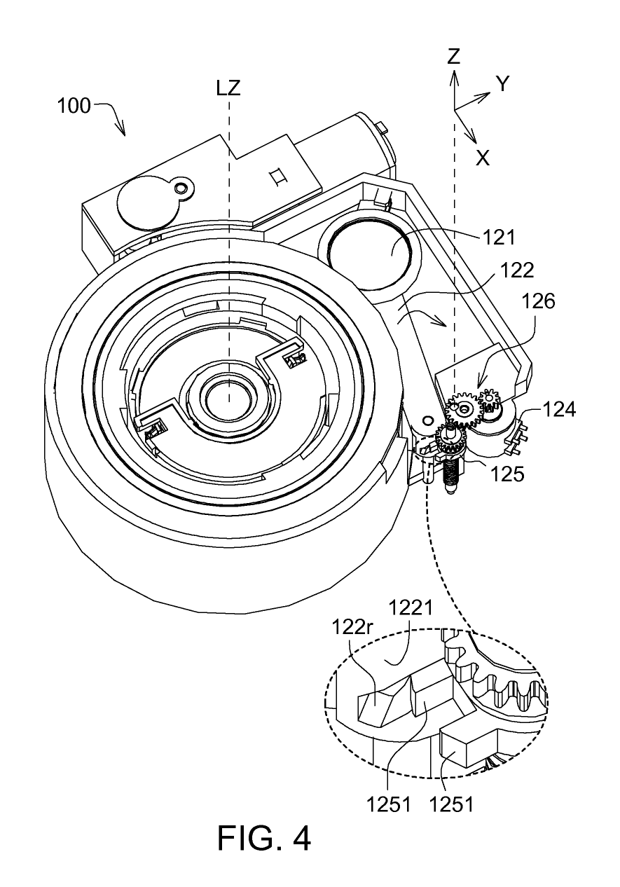

FIG. 4 shows a local three-dimensional view of the focus module of FIG. 2. The rotatable arm 122 has a sliding groove 122r connected to a protrusion 1251 of the guider 125. Through the connection between the sliding groove 122r and the protrusion 1251, the rotatable arm 122 is rotated by the guider 125. The sliding groove 122r is formed on a pivot 1221 of the rotatable arm 122 and the pivot 1221 is pivotally connected to the casing 200.

The sliding groove 122r is extended along and around the Z-axis.

As a result, the lens mechanism 100 is changed to collapse state from the stand-by state, the guider 125 drives the rotatable arm 122 to move in a straight line along the Z-axis and swing around the Z-axis, and accordingly, the focus lens 121 is driven to be away from the optical axis LZ. Since the focus lens 121 is driven to be away from the optical axis LZ, a space is spared to accommodate other components (such as the lens mechanism 100), such that the whole thickness of the lens mechanism 100 become thinner in the collapse state.

The formed image for the optical system LG is less sensitive to the variation in position of the focus lens 121 in comparison with the lens 112 of the zooming lens group ZL. Accordingly, the whole effect on the formed image is impervious to the variation in position generated by the rotatable arm 122 driving the focus lens 121 to move in a direction pen perpendicular the optical axis LZ repeatedly, and thus the whole effect on the formed image is controllable.

In addition, after the electronic device 10 is turned on, the lens mechanism 100 is changed to the stand-by state from the collapse state, the rotatable arm 122 simultaneously brings the focus lens 121 to be located at the optical axis LZ. When the electronic device 10 is in the stand-by state or shutdown, the lens mechanism 100 start to close, the rotatable arm 122 simultaneously brings the focus lens 121 to be away from the optical axis LZ. The movement principle of the rotatable arm 122 driving the focus lens 121 to be away from the optical axis LZ is similar to that of the rotatable arm 122 driving the focus lens 121 to be away from the optical axis LZ, and the similarities are not repeated here.

In FIG. 4, the transmission mechanism 126 is gear group; however, in another embodiment, the transmission mechanism 126 is belt pulley group. As long as a transmission mechanism is able to drive the leading screw 123 to revolve on its own axis, such transmission mechanism can sever as the transmission mechanism 126.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A lens mechanism having an optical axis and comprising:
a zoom module moving perpendicular to the optical axis;
a focus module comprising a rotatable arm; and
a focusing lens group disposed on the rotatable arm;
wherein when the lens mechanism is in a stand-by state, the focusing lens group is located at the optical axis; when the lens mechanism is in a collapse state, the focusing lens group is away from the optical axis.

2. The lens mechanism according to claim 1, wherein the zoom module moves in two dimensions or circumference perpendicular to the optical axis.

3. The lens mechanism according to claim 2, wherein the lens mechanism further comprises a zooming lens group, the zoom module comprises an optical image stabilizer, and at least one lens of the zooming lens group is disposed on the optical image stabilizer.

4. The lens mechanism according to claim 1, wherein the focus module further comprises a guider having a protrusion, and the rotatable arm is rotated by the protrusion of the guider.

5. The lens mechanism according to claim 4, wherein the rotatable arm has a sliding groove connected to the protrusion.

6. The lens mechanism according to claim 5, wherein the sliding groove is formed on a pivot of the rotatable arm.

7. The lens mechanism according to claim 1, wherein the focus module further comprises a leading screw, and the guider is screwed to the leading screw.

8. The lens mechanism according to claim 7, wherein the focus module further comprises a driver for revolving the leading screw, and the leading screw, the driver and the guider are disposed outside a periphery of the zoom module.

9. The lens mechanism according to claim 1, wherein from the stand-by state to the collapse status, the rotatable arm brings the focus module outside a periphery of the zoom module.

10. A device comprising a lens mechanism according to claim 1.

11. A lens mechanism having an optical axis and comprising:
a focusing lens; and
a focus module comprising a rotatable arm;
wherein when the lens mechanism is in a stand-by state, the focusing lens is located at the optical axis by the rotatable arm; when the lens mechanism is in a collapse status, the focusing lens away from the optical axis by the rotatable arm.

12. The lens mechanism according to claim 11, wherein the zoom module brings a lens of the zooming lens group to move in a direction perpendicular to the optical axis.

13. The lens mechanism according to claim 12, wherein the lens mechanism further comprises a zooming lens group and a zoom module, and the zooming lens group is disposed on the zoom module.

14. The lens mechanism according to claim 11, wherein the focus module further comprises a guider, and the rotatable arm rotates by a protrusion of the guider.

15. The lens mechanism according to claim 14, further comprises:
a leading screw; and
a driver driving the leading screw to revolve on its own axis;
wherein the guider is screwed to the leading screw and moves in one dimension by rotation along the leading screw, and the rotatable arm comprises a sliding groove, and a cam of the guider moves in a straight line and revolves on its own axis for driving the rotatable arm to swing.

16. A device comprising a lens mechanism according to claim 11.

17. A lens mechanism having an optical axis and comprising:
an optical system comprising a zooming lens group and a focusing lens group;
a zoom module holding a lens of the zooming lens group;
a focus module leading the focusing lens group away from the optical
axis when the lens mechanism is in a collapse state.

18. The lens mechanism according to claim 17, wherein the focus module comprises a rotatable arm to bring the focusing lens group away from the optical axis.

19. The lens mechanism according to claim 17, wherein the zoom module brings a lens of the zooming lens group to move in a direction perpendicular to the optical axis.

20. A device, comprising a lens mechanism according to claim 17.
